(19) United States
(12) Patent Application Publication
(10) Pub. No.: US 2014/0180446 A1
(43) Pub. Date: Jun. 26, 2014

(54) SYSTEM AND METHOD FOR CONTROLLING ELECTRONIC DEVICE USING ANOTHER ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: YANG PENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/968,377

(22) Filed: Aug. 15, 2013

(30) Foreign Application Priority Data
Dec. 21, 2012 (CN) 2012105602910

(51) Int. Cl. G05B 15/02

(52) U.S. Cl. CPC G05B 15/02
USPC 700/84; 700/83

(57) ABSTRACT

An electronic device is controlled by another electronic device which is installed with same operating system as the electronic device. An interface corresponding to an interface of the another electronic device, receives control signals generated by the another electronic device. An application module decodes the control signals. A virtual driver recognizes the type of user input contained in each control signal and transmit each control signal to a corresponding one of the drivers. The drivers interprets each control signal as a command of a corresponding one of the applications. At least one application executes the command.

### BACKGROUND

1. Technical Field

The present disclosure relates to a system and a method for controlling an electronic device using another electronic device.

2. Description of Related Art

At present, various electronic devices, such as computers, cell phones, and digital televisions, may employ the same operating system. However, the electronic device cannot be used to control another electronic device. For example, a cell phone cannot be used to control a digital television installed with the same operating system as the cell phone.

Therefore, what is needed is to provide a system and a method that can overcome the above-described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 shows a system having a first electronic device and a second electronic device, according to an embodiment.

FIG. 2 shows a method for controlling the second electronic device using the first electronic device, according to an embodiment

### DETAILED DESCRIPTION

Reference will be made to the drawings to describe certain exemplary embodiments of the present disclosure.

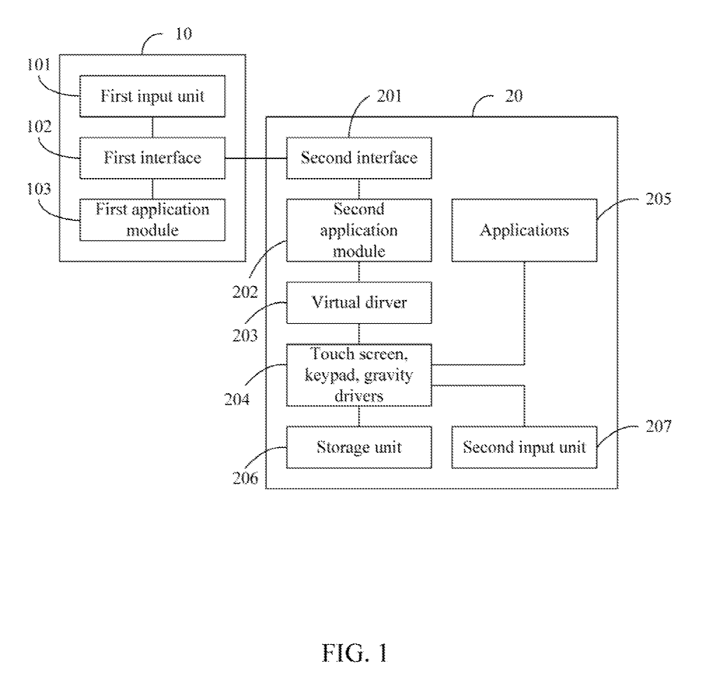

FIG. 1 shows a system having a first electronic device 10 and a second electronic device 20, according to an embodiment. The first electronic device 10 and the second electronic device 20 are installed with the same operating system. The first electronic device 10, such as a cell phone, includes a first input unit 101, a first interface 102, and a first application module 103.

The first input unit 101 can be a touch screen, a keypad, or a gravity sensor. The first input unit 101 is configured to receive user inputs, such as touches on the touch screen, operation of the keypad, and motions of the first electronic device 10 sensed by the gravity sensor. The first interface 102 can be a wireless local area network (WLAN) transceiver or a Bluetooth transceiver. The first application module 103, when executed in the operating system of the first electronic device 10, can perform desired tasks, for example, packaging, and transmitting the user inputs as a control signal via the first interface 102.

The second electronic device 20, such as a digital television, includes a second interface 201, a second application module 202, a virtual driver 203, various drivers 204, various applications 205, a storage unit 206, and a second input unit 207.

The second interface 201 can be a WLAN transceiver or a Bluetooth transceiver, corresponding to the first interface 102. The second electronic device 20 can be wirelessly connected with the first electronic device 10 by connecting the first interface 102 with the second interface 201.

The second application module 202, when executed in the operating system of the second electronic device 10, can perform desired tasks, for example, decoding the control signal through the first interface 102 and the second interface 201, to get the contents of the control signal to understand the control signal.

The virtual driver 203 is configured to recognize a type of the user input, such as a touch, an operation of keypad, and a motion of the first electronic device 10, contained in the control signal, and transmits the control signal to a corresponding one of the drivers 204.

The drivers 204, such as a touch screen driver, a keypad driver, and a gravity driver, are configured to interpret the corresponding type of user input as a corresponding command of a corresponding one of the applications 205, such as applications for displaying audio/video.

In this embodiment, the storage unit 206 stores a table including a collection of user inputs and a collection of commands of each of the applications 205. Each user input is associated with one command of each of the applications 205. Each user input can be represented by four values (tag, x value, y value, z value), wherein “tag” represents the type of the user input, for example, 1 is the touch on the touch screen, 2 is motion of the first electronic device 10, and 3 is the operation of the keypad, wherein “x value” and “y value” are x and y coordinate values of the touch when tag is 1, x-axis and y-axis accelerations when tag is 2, and key value and null when the tag is 3, wherein “z value” is a specific action of the touch when the tag is 1 (for example, 0 represents releasing of a touch and 1 represents a depressing of the touch), a z-axis acceleration when the tag is 2, and a specific action of the operation of the keypad when tag is 3 (for example, 1 representing releasing of a key and 1 represent depressing down of the key).

The second input unit 207 allows the second electronic device 20 to self-input when is not being controlled by the first electronic device 10 and generates the control signals to control other electronic devices having same operating system as the first electronic device 10 and the second electronic device 20. The second input unit 207 can be a touch screen and a keypad.

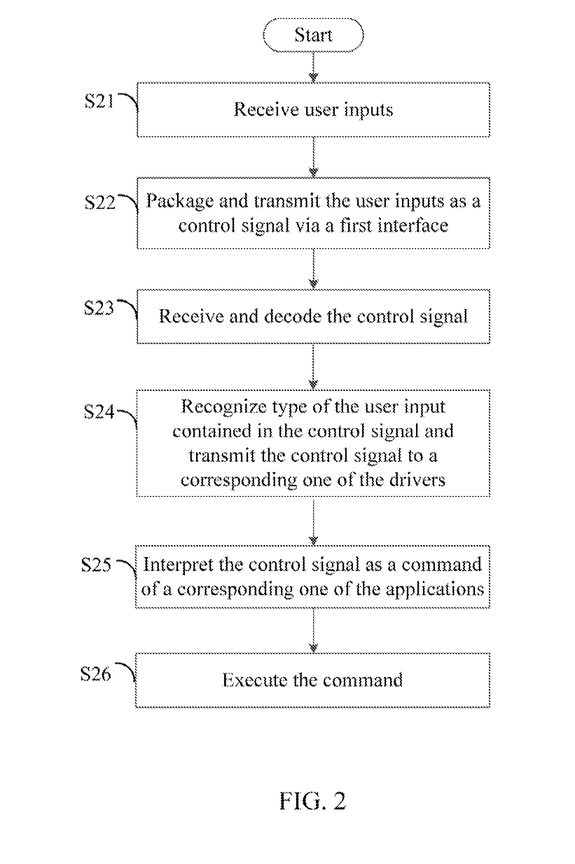

FIG. 2 shows a method for controlling the second electronic device 20 using the first electronic device 10, according to an embodiment. The method includes the following steps S21-S27.

In step S21, the first electronic device 10 and the second electronic device 20 are wirelessly connected by connecting the first interface 102 with the second interface 201. The first application module 103 and the second application module 202 are executed. Then, the first input unit 101 receives a user input.

In step S22, the first application module 203 packages, and transmits the user input as a control signal to the second electronic device 20 via wireless connection between the first interface 102.

In step S23, the second interface 201 receives the control signal, and the second application module 202 decodes the control signal.

In step S24, the virtual driver 203 recognizes the type of the user input contained in the control signal and transmits the control signal to a corresponding one of the drivers 204.

In step S25, the drivers 204 interpret the control signal as a command of a corresponding one of the applications 205 by indexing the table stored in the storage unit 206.

In step S26, the applications 205 executes the command.

It is to be further understood that even though numerous characteristics and advantages of preferred and exemplary embodiments have been set out in the foregoing description, together with details of the structures and functions of the embodiments, the disclosure is illustrative only; changes may be made in detail, especially in the matters of shape, size and arrangement of parts within the principles of the present disclosure to the full extent indicated by the broad general meaning of the terms in which the appended claims are expressed.

What is claimed is:

1. An electronic device controlled by another electronic device which is installed with same operating system as the electronic device, comprising:
an interface corresponding to an interface of the another electronic device, to receive control signals generated by the another electronic device;
an application module, to decode the control signals;
a virtual driver, to recognize type of user input contained in each control signal and transmit each control signal to a corresponding one of the drivers;
the drivers, to interpret each control signal as a command of a corresponding one of the applications; and
at least one application, to execute the command.

2. The electronic device of claim 1, wherein the drivers interprets each control signal as a command of a corresponding one of the applications by indexing a table stored in a storage unit.

3. The electronic device of claim 1, wherein the interface is a wireless local area network transceiver or a Bluetooth transceiver.

4. The electronic device of claim 1, further comprising an input unit to generate the control signals to control other electronic devices having same operating system as the electronic device and the another electronic device.

5. The electronic device of claim 4, wherein the input unit is a touch screen and a keypad.

6. An method for controlling an electronic device by another electronic device which installed with same operating system, comprising:
receiving control signals generated by the another electronic device through an interface;
decoding the control signals through an application module;
recognizing type of user input contained in each control signal and transmit each control signal to a corresponding one of the drivers;
interpreting each control signal as a command of a corresponding one of the applications by the drivers; and
executing the command by at least one application in the electronic device.

7. The method of claim 6, wherein the method of interpreting each control signal as a command of a corresponding one of the applications by the drivers further comprises interpreting each control signal as a command of a corresponding one of the applications by indexing a table stored in a storage unit.

8. The method of claim 6,wherein the interface is a wireless local area network transceiver or a Bluetooth transceiver.

9. The method of claim 6, further comprising generating the control signals by an input unit to control other electronic devices having same operating system as the electronic device and the another electronic device.

10. The method of claim 9, wherein the input unit is a touch screen and a keypad.
